(19) United States
(12) Patent Application Publication
(10) Pub. No.: US 2022/0283778 A1
(43) Pub. Date: Sep. 8, 2022

(54) METHOD AND DEVICE FOR ENCODING

(71) Applicants: SAMSUNG ELECTRONICS CO., LTD., Suwon-si (KR); Korea Advanced Institute of Science and Technology, Daejeon (KR)

(72) Inventors: Yeongjae CHOI, Suwon-si (KR); Seungkyu CHOI, Daejeon (KR); Lee-Sup KIM, Daejeon (KR); Jaekang SHIN, Daejeon (KR)

(73) Assignees: SAMSUNG ELECTRONICS CO., LTD., Suwon-si (KR); Korea Advanced Institute of Science and Technology, Daejeon (KR)

(21) Appl. No.: 17/401,453

(22) Filed: Aug. 13, 2021

(30) Foreign Application Priority Data
Mar. 4, 2021 (KR) 10-2021-0028929
Mar. 17, 2021 (KR) 10-2021-0034835

(51) Int. Cl. G06F 7/487; G06F 7/544

(52) U.S. Cl. CPC G06F 7/4876; G06F 7/5443

(57) ABSTRACT

An encoding method includes receiving input data represented by a 16-bit half floating point, adjusting a number of bits of an exponent and a mantissa of the input data to split the input data into 4-bit units, and encoding the input data in which the number of bits has been adjusted such that the exponent is a multiple of “4”.

### CROSS-REFERENCE TO RELATED APPLICATIONS

This application claims the benefit under 35 USC § 119(a) of Korean Patent Application No. 10-2021-0028929 filed on Mar. 4, 2021, and Korean Patent Application No. 10-2021-0034835 filed on Mar. 17, 2021, in the Korean Intellectual Property Office, the entire disclosures, all of which, are incorporated herein by reference for all purposes.

### BACKGROUND

### 1. Field

The following description relates to a method and device for encoding.

### 2. Description of Related Art

An artificial neural network (ANN) is implemented based on a computational architecture. Due to the development of ANN technologies, research is being actively conducted to analyze input data using ANNs in various types of electronic systems and extract valid information. A device to process an ANN requires a large amount of computation for complex input data. Accordingly, there is a desire for a technique for analyzing a large volume of input data in real time using an ANN and efficiently processing an operation related to the ANN to extract desired information.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, an encoding method includes receiving input data represented by a 16-bit half floating point, adjusting a number of bits of an exponent and a mantissa of the input data to split the input data into 4-bit units and, encoding the input data in which the number of bits has been adjusted such that the exponent is a multiple of “4”.

The adjusting of the number of bits may include assigning 4 bits to the exponent, and assigning 11 bits to the mantissa.

The encoding may include calculating a quotient and a remainder obtained when a sum of the exponent of the input data and “4” is divided by “4”, encoding the exponent based on the quotient, and encoding the mantissa based on the remainder.

The encoding of the exponent may include encoding the exponent based on the quotient and a bias.

The encoding of the mantissa may include determining a first bit value of the mantissa to be “1”, if the remainder is “0”.

The encoding of the mantissa may include determining a first bit value of the mantissa to be “0” and a second bit value of the mantissa to be “1”, if the remainder is “1”.

The encoding of the mantissa may include determining a first bit value of the mantissa to be “0”, a second bit value of the mantissa to be “0”, and a third bit value of the mantissa to be “1”, if the remainder is “2”.

The encoding of the mantissa may include determining a first bit value of the mantissa to be “0”, a second bit value of the mantissa to be “0”, a third bit value of the mantissa to be “0”, and a fourth bit value to be “1”, if the remainder is “3”.

In another general aspect, an operation method includes receiving first operand data represented by a 4-bit fixed point, receiving second operand data that are 16 bits wide, determining a data type of the second operand data, encoding the second operand data, if it is determined the second operand data are of a floating-point type, and splitting the encoded second operand data into four 4-bit bricks, splitting the second operand data into four 4-bit bricks for a parallel data operation, if it is determined the second operand data are of a fixed-point type, and performing a multiply-accumulate (MAC) operation between the second operand data split into the four bricks and the first operand data.

The encoding may include adjusting a number of bits of an exponent and a mantissa of the second operand data, so as to split the second operand data into 4-bit units, and encoding the second operand data in which the number of bits is adjusted such that the exponent is a multiple of “4”.

The splitting may include splitting the encoded second operand data into one exponent brick data and three mantissa brick data.

The performing of the MAC operation may include performing a multiplication operation between the first operand data and each of the three mantissa brick data, comparing the exponent brick data with accumulated exponent data stored in an exponent register, and accumulating a result of performing the multiplication operation to accumulated mantissa data stored in each of three mantissa registers, based on a result of the comparing.

The accumulating may include aligning accumulation positions of the result of performing the multiplication operation and the accumulated mantissa data stored in each of the three mantissa registers, based on the result of the comparing.

In still another general aspect, an encoding device may include a processor configured to receive input data represented by a 16-bit half floating point, adjust a number of bits of an exponent and a mantissa of the input data to split the input data into 4-bit units, and encode the input data in which the number of bits has been adjusted such that the exponent is a multiple of “4”.

The processor may be further configured to assign 4 bits to the exponent, and assign 11 bits to the mantissa.

The processor may be further configured to calculate a quotient and a remainder obtained when a sum of the exponent of the input data and “4” is divided by “4”, encode the exponent based on the quotient, and encode the mantissa based on the remainder.

In a further general aspect, an operation device includes a processor configured to receive first operand data represented by a 4-bit fixed point, receive second operand data that are 16 bits wide, determine a data type of the second operand data, encode the second operand data, if it is determined the second operand data are of a floating-point type and split the encoded second operand data into four 4-bit bricks, split the second operand data into four 4-bit bricks for a parallel data operation, if it is determined the second operand data are of a fixed-point type, and perform a MAC operation between the second operand data split into the four bricks and the first operand data.

The processor may be further configured to adjust a number of bits of an exponent and a mantissa of the second operand data, so as to split the second operand data into 4-bit units, and encode the second operand data in which the number of bits is adjusted such that the exponent is a multiple of “4”.

The processor may be further configured to split the encoded second operand data into one exponent brick data and three mantissa brick data.

The processor may be further configured to perform a multiplication operation between the first operand data and each of the three mantissa brick data, compare the exponent brick data with accumulated exponent data stored in an exponent register, and accumulate a result of performing the multiplication operation to accumulated mantissa data stored in each of three mantissa registers, based on a result of the comparing.

The processor may be further configured to align accumulation positions of the result of performing the multiplication operation and the accumulated mantissa data stored in each of the three mantissa registers, based on the result of the comparing.

In another general aspect, an operation method includes: receiving first data represented by a 4-bit fixed point; receiving second data that are 16 bits wide; encoding the second operand data, in a case in which the second operand data are of a floating-point type, and splitting the encoded second operand data into four 4-bit bricks; splitting the second operand data into four 4-bit bricks without encoding the second operand data, in a case in which the second operand data are of a fixed-point type; and performing a multiply-accumulate (MAC) operation between the split second operand data and the first operand data.

Other features and aspects will be apparent from the following detailed description, the drawings, and the claims.

### BRIEF DESCRIPTION OF THE DRAWINGS

FIG. 1A illustrates an example of a method of performing deep learning operations using an artificial neural network (ANN).

FIG. 1B illustrates an example of filters and data of an input feature map provided as an input in a deep learning operation.

FIG. 1C illustrates an example of performing a convolution operation based on deep learning.

FIG. 1D illustrates an example of performing a convolution operation using a systolic array.

FIG. 2 illustrates an example of an encoding method.

FIG. 3 illustrates an example of an encoding method.

FIG. 4 illustrates an example of an operation method.

FIG. 5 illustrates an example of performing a multiply-accumulate (MAC) operation between first operand data represented by a 4-bit fixed point and second operand data represented by a 16-bit half floating point.

FIG. 6 illustrates an example of aligning data according to an exponent difference.

FIG. 7 illustrates an example of an operation device.

Throughout the drawings and the detailed description, unless otherwise described or provided, the same drawing reference numerals will be understood to refer to the same elements, features, and structures. The drawings may not be to scale, and the relative size, proportions, and depiction of elements in the drawings may be exaggerated for clarity, illustration, and convenience.

### DETAILED DESCRIPTION

The following structural or functional descriptions are exemplary to merely describe the examples, and the scope of the examples is not limited to the descriptions provided in the present specification.

Terms, such as first, second, and the like, may be used herein to describe components. Each of these terminologies is not used to define an essence, order or sequence of a corresponding component but used merely to distinguish the corresponding component from other component(s). For example, a “first” component may be referred to as a “second” component, or similarly, and the “second” component may be referred to as the “first” component within the scope of the right according to the concept of the present disclosure.

It should be noted that if it is described that one component is “connected”, “coupled”, or “joined” to another component, a third component may be “connected”, “coupled”, and “joined” between the first and second components, although the first component may be directly connected, coupled, or joined to the second component. On the contrary, it should be noted that if it is described that one component is “directly connected”, “directly coupled”, or “directly joined” to another component, a third component may be absent. Expressions describing a relationship between components, for example, “between”, directly between”, or “directly neighboring”, etc., should be interpreted to be alike.

The singular forms “a”, “an”, and “the” are intended to include the plural forms as well, unless the context clearly indicates otherwise. It should be further understood that the terms “comprises” and/or “comprising,” when used in this specification, specify the presence of stated features, integers, steps, operations, elements, components or a combination thereof, but do not preclude the presence or addition of one or more other features, integers, steps, operations, elements, components, and/or groups thereof.

Unless otherwise defined, all terms, including technical and scientific terms, used herein have the same meaning as commonly understood by one of ordinary skill in the art to which this disclosure pertains. Terms, such as those defined in commonly used dictionaries, are to be interpreted as having a meaning that is consistent with their meaning in the context of the relevant art, and are not to be interpreted in an idealized or overly formal sense unless expressly so defined herein.

The examples may be implemented as various types of products such as, for example, a data center, a server, a personal computer, a laptop computer, a tablet computer, a smart phone, a television, a smart home appliance, an intelligent vehicle, a kiosk, and a wearable device. Hereinafter, example embodiments will be described in detail with reference to the accompanying drawings. In the drawings, like reference numerals are used for like elements.

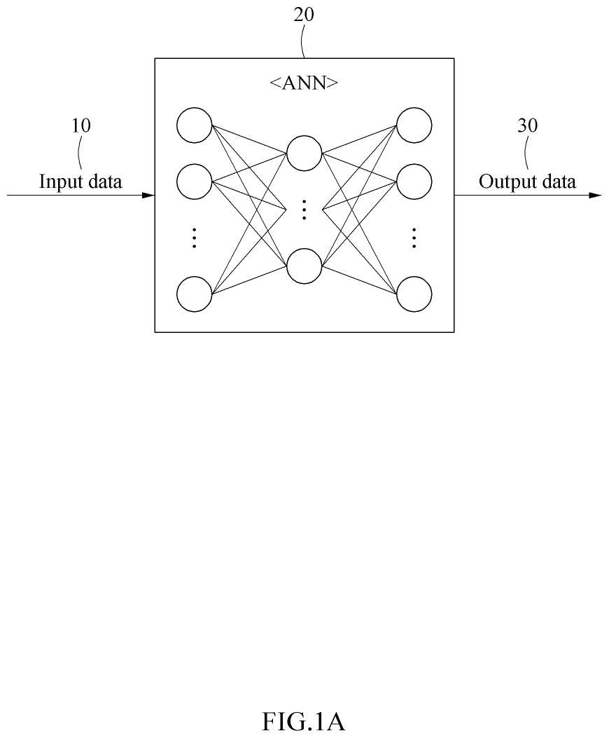

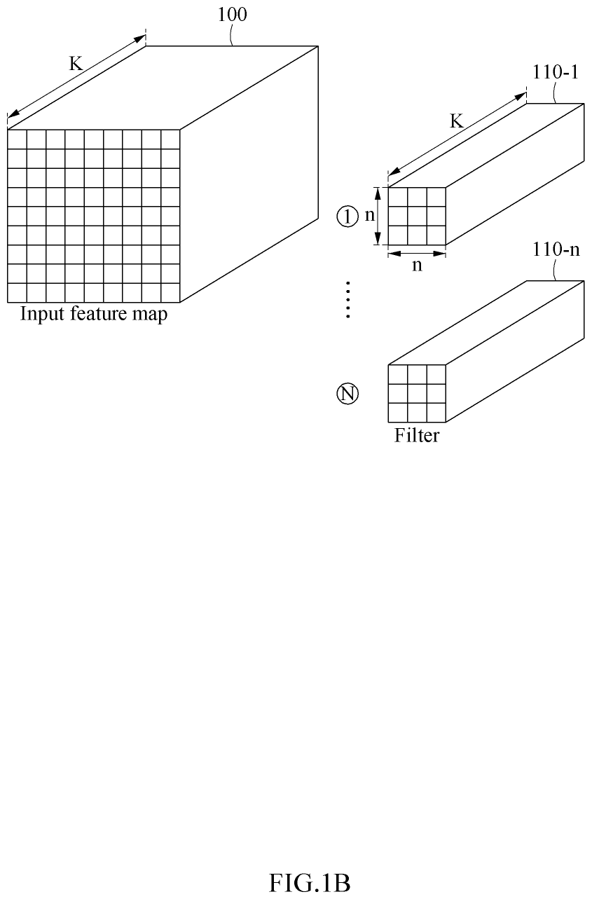

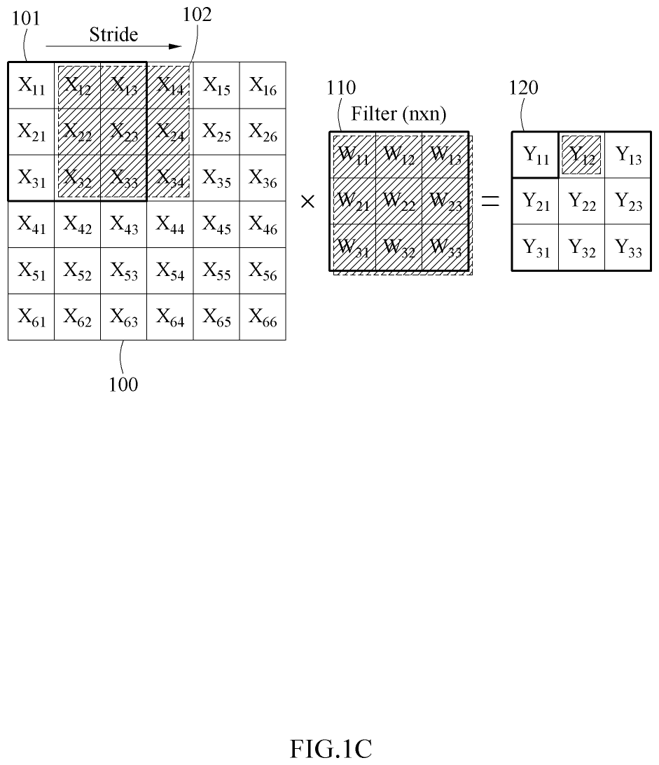

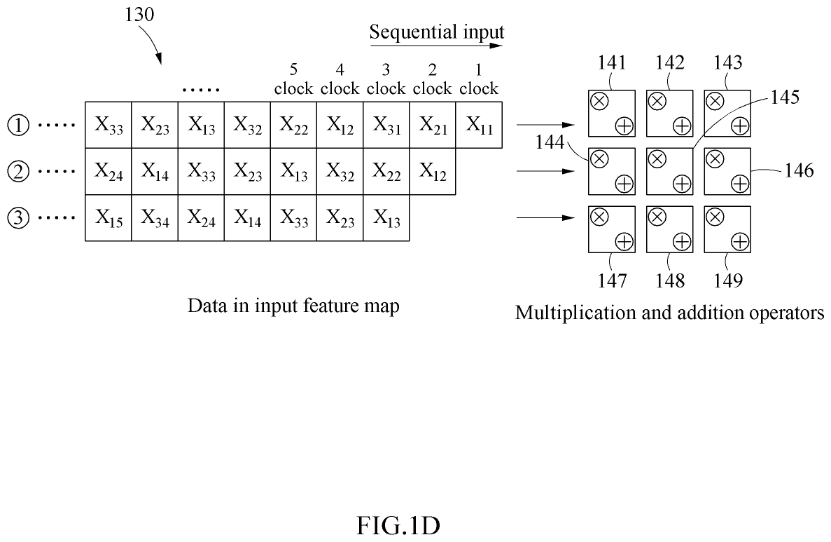

FIG. 1A illustrates an example of a method of performing deep learning operations using an artificial neural network (ANN).

An artificial intelligence (AI) algorithm including deep learning may input data 10 to an ANN, and may learn output data 30 through an operation, for example, a convolution. The ANN may be a computational architecture obtained by modeling a biological brain. In the ANN, nodes corresponding to neurons of a brain may be connected to each other and may collectively operate to process input data. Various types of neural networks may include, for example, a convolutional neural network (CNN), a recurrent neural network (RNN), a deep belief network (DBN), or a restricted Boltzmann machine (RBM), but is not limited thereto. In a feed-forward neural network, neurons may have links to other neurons. The links may be expanded in a single direction, for example, a forward direction, through a neural network.

FIG. 1A illustrates a structure in which the input data 10 is input to the ANN and in which output data 30 is output through the ANN. The ANN may include at least one layer and may be, for example, a CNN 20. The ANN may be, for example, a deep neural network (DNN) including at least two layers.

The CNN 20 may be used to extract “features”, for example, a border or a line color, from the input data 10. The CNN 20 may include a plurality of layers. Each of the layers may receive data, may process data input to a corresponding layer and may generate data that is to be output from the corresponding layer. Data output from a layer may be a feature map generated by performing a convolution operation of an image or a feature map that is input to the CNN 20 and weights of at least one filter. Initial layers of the CNN 20 may operate to extract features of a relatively low level, for example, edges or gradients, from an input, such as image data. Subsequent layers of the CNN 20 may gradually extract more complex features, for example, an eye or a nose in an image.

FIG. 1B illustrates an example of filters and data of an input feature map provided as an input in a deep learning operation.

Referring to FIG. 1B, an input feature map 100 may be a set of numerical data or pixel values of an image input to an ANN, but is not limited thereto. In FIG. 1B, the input feature map 100 may be defined by pixel values of a target image that is to be trained using the ANN. For example, the input feature map 100 may have 256×256 pixels and a depth with a value of K. However, the above values are merely examples, and a size of the pixels of the input feature map 100 is not limited thereto.

N filters, for example, filters 110-1 to 110-n may be formed. Each of the filters 110-1 to 110-n may include n×n weights. For example, each of the filters 110-1 to 110-n may be 3×3 pixels and have a depth value of K. However, the above size of each of the filters 110-1 to 110-n is merely an example and is not limited thereto.

FIG. 1C illustrates an example of performing a convolution operation based on deep learning.

Referring to FIG. 1C, the process of performing a convolutional operation in an ANN may be the process of generating, in each layer, output values through a multiplication and addition operation between an input feature map 100 and a filter 110 and generating an output feature map 120 using a cumulative sum of the output values.

The convolution operation process is the process of performing multiplication and addition operations by applying a predetermined-sized, that is, n×n filter 110 to the input feature map 100 from the upper left to the lower right in a current layer. Hereinafter, the process of performing a convolution operation using a 3×3 filter 110 will be described.

For example, first, an operation of multiplying 3×3 pieces of data in a first region 101 on the upper left side of the input feature map 100 by weights W₁₁ to W₃₃ of the filter 110, respectively, is performed. Here, the 3×3 pieces of data in the first region 101 are a total of nine pieces of data X₁₁ to X₃₃ including three pieces of data in a first direction and three pieces of data in a second direction. Thereafter, first-first output data Y₁₁ in the output feature map 120 are generated using a cumulative sum of the output values of the multiplication operation, in detail, X₁₁×W₁₁, X₁₂×W₁₂, X₁₃×W₁₃, X₂₁×W₂₁, X₂₂×W₂₂, X₂₃×W₂₃, X₃₁×W₃₁, X₃₂×W₃₂, and X₃₃×W₃₃.

Thereafter, an operation is performed by shifting the unit of data from the first region 101 to a second region 102 on the upper left side of the input feature map 100. In this example, the number of pieces of data shifted in the input feature map for the convolution operation process is referred to as a stride. The size of the output feature map 120 to be generated may be determined based on the stride. For example, when the stride is “1”, an operation of multiplying a total of nine pieces of input data X₁₂ to X₃₄ included in the second region 102 by the weights W₁₁ to W₃₃ of the filter 110 is performed, and first-second output data Y₁₂ in the output feature map 120 are generated using a cumulative sum of the output values of the multiplication operation, in detail, X₁₂×W₁₁, X₁₃×W₁₂, X₁₄×W₁₃, X₂₂×W₂₁, X₂₃×W₂₂, X₂₄×W₂₃, X₃₂×W₃₁, X₃₃×W₃₂, and X₃₄×W₃₃.

FIG. 1D illustrates an example of performing a convolution operation using a systolic array.

Referring to FIG. 1D, data in an input feature map 130 may be mapped to a systolic array sequentially input to processing elements (PEs) 141, 142, 143, 144, 145, 146, 147, 149, and 149 according to clocks with a predetermined latency. The PEs may be multiplication and addition operators.

In a first clock, first-first data X₁₁ in a first row \textcircled{1} of the systolic array may be input to the first PE 141. Although not shown in FIG. 1D, the first-first data X₁₁ may be multiplied by the weight W₁₁ in the first clock. Thereafter, in a second clock, the first-first data X₁₁ may be input to the second PE 142, second-first data X₂₁ may be input to the first PE 141, and first-second data X₁₂ may be input to the fourth PE 144. Similarly, in a third clock, the first-first data X₁₁ may be input to the third PE 143, the second-first data X₂₁ may be input to the second PE 142, and the first-second data X₁₂ may be input to the fifth PE 145. In addition, in the third clock, third-first data X₃₁ may be input to the first PE 141, second-second data X₂₂ may be input to the fourth PE 144, and first-third data X₁₃ may be input to the seventh PE 147.

As described above, the input feature map 130 may be sequentially input to the PEs 141 to 149 according to the clocks, and multiplication and addition operations with the weights input according to the clocks may be performed. An output feature map may be generated using cumulative sums of values output through multiplication and addition operations between weights and data in the input feature map 130 that are sequentially input.

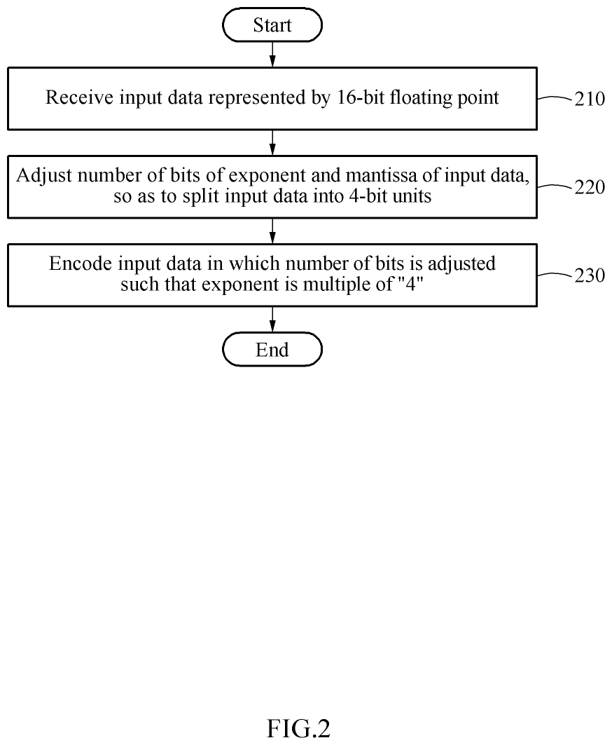

FIG. 2 illustrates an example of an encoding method.

Operations of FIG. 2 may be performed in the shown order and manner. However, the order of some operations may be changed, or some operations may be omitted, without departing from the spirit and scope of the shown example. The operations shown in FIG. 2 may be performed in parallel or simultaneously. In FIG. 2, one or more blocks and a combination thereof may be implemented by a special-purpose hardware-based computer that performs a predetermined function, or a combination of computer instructions and special-purpose hardware.

An operation using a neural network may require a different operation format according to the type of application. For example, an application configured to determine a type of object in an image may require a lower-bit precision than 8-bit, and a speech-related application may require a higher-bit precision than 8-bit.

Input operands of a multiply-accumulate (MAC) operation, which are essential operators in deep learning, may also be configured with various precisions depending on the situation. For example, a gradient, one of the input operands required for training a neural network, may require a precision of about a 16-bit half floating point, and the other input operands, an input feature map and weights, may be processed even with a low-precision fixed point.

The basic method to process data with such various requirements is generating and using hardware components for performing a MAC operation for each input type using unnecessarily many hardware resources.

In order to perform MAC operations for various input types using single hardware, operation units of the hardware need to be designed based on a data type with the highest complexity. However, in this example, it is inefficient to perform an operation through operators generated based on high-precision data with the highest complexity when a low-precision operation is input. More specifically, a hardware implementation area may unnecessarily increase, and the hardware power consumption may also unnecessarily increase.

According to an encoding method and an operation method provided herein, it is possible to maintain a gradient operation in the training process at high precision and simultaneously efficiently drive a low-precision inference process.

In operation 210, an encoding device receives input data represented by a 16-bit floating point.

In operation 220, the encoding device adjusts a number of bits of an exponent and a mantissa of the input data, so as to split the input data into 4-bit units. The encoding device may adjust the number of configuration bits in the form of {sign, exponent, mantissa}={1,4,11}, so as to split a bit distribution {sign, exponent, mantissa}={1,5,10} of an existing 16-bit half floating point into 4-bit units. As a result, the bits assigned to the exponent decrease by one, and the bits of the mantissa increase by one, to 11 bits.

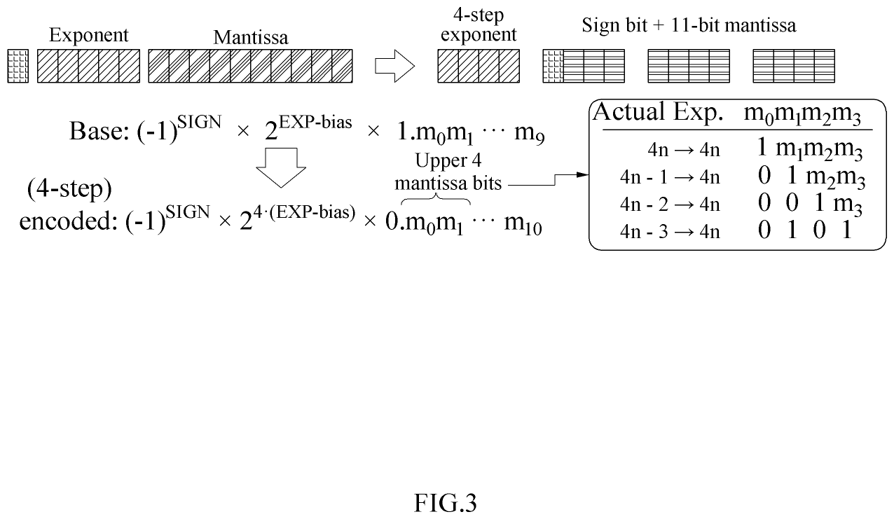

In operation 230, the encoding device encodes the input data in which the number of bits is adjusted such that the exponent is a multiple of “4”. The encoding device may secure a wider exponent range than the existing 16-bit half floating point and simultaneously encode the exponent with “4” steps to be easily used for a bit-brick operation. Hereinafter, the encoding method will be described in detail with reference to FIG. 3.

FIG. 3 illustrates an example of an encoding method.

Prior to describing the encoding method, a method of representing data by a floating point will be described. For example, the decimal number 263.3 may be the binary number 100000111.0100110 . . . , which may be represented as 1.0000011101×2⁸. Furthermore, expressing this using a floating point, the bit (1-bit) of the sign may be 0 (positive number), and the bit (5-bit) of the exponent may be 11000(8+16(bias)), and the bit of the mantissa may be 0000011101(10 bit), it may be finally represented as 0110000000011101.

Referring to FIG. 3, an encoding device may adjust a number of configuration bits in the form of {sign, exponent, mantissa}={1,4,11}. For example, by adjusting 1.0000011101×2⁸ in the above example to 0.10000011101×2⁹, 1 bit may be assigned to the sign, 4 bits may be assigned to the exponent, and 11 bits may be assigned to mantissa.

The encoding device may encode the input data in which the number of bits is adjusted such that the exponent is a multiple of “4”. In more detail, the encoding device may calculate a quotient and a remainder obtained when a sum of the exponent of the input data and “4” is divided by “4”, encode the exponent based on the quotient, and encode the mantissa based on the remainder.

The encoding device may encode the exponent based on the quotient and a bias.

The encoding device may determine a first bit value of the mantissa to be “1”, if the remainder is “0”, determine the first bit value of the mantissa to be “0” and a second bit value of the mantissa to be “1”, if the remainder is “1”, determine the first bit value of the mantissa to be “0”, the second bit value of the mantissa to be “0”, and a third bit value of the mantissa to be “1”, if the remainder is “2”, and determine the first bit value of the mantissa to be “0”, the second bit value of the mantissa to be “0”, the third bit value of the mantissa to be “0”, and a fourth bit value to be “1”, if the remainder is “3”. This is represented as in Table 1.

TABLE 1

| | | Exp. | |
|---|---|---|---|
| Representation | Encoded Vet. | (b: bias) | Mantissa |
| 0.1xxxxxxxxxx × | 0.1xxxxxxxxxx × | n + b | 1xxxxxxxxxx |
| 2⁴ⁿ | 2⁴ⁿ | | |
| 0.1xxxxxxxxxx × | 0.01xxxxxxxxx × | n + b | 01xxxxxxxxx |
| 2⁴ⁿ⁻¹ | 2⁴ⁿ | | |
| 0.1xxxxxxxxxx × | 0.001xxxxxxxx × | n + b | 001xxxxxxxx |
| 2⁴ⁿ⁻² | 2⁴ⁿ | | |
| 0.1xxxxxxxxxx × | 0.0001xxxxxxx × | n + b | 0001xxxxxxx |
| 2⁴ⁿ⁻³ | 2⁴ⁿ | | |
| 0.1xxxxxxxxxx × | 0.1xxxxxxxxxx × | n − 1 + b | 1xxxxxxxxxx |
| 2⁴ⁿ⁻⁴ | 2⁴⁽ⁿ⁻¹⁾ | | |

For example, the encoding device may convert 0.10000011101×2⁹ to 0.10000011101×2^{4×3-3}, and again to 0.00010000011101×2^{4×3}. Based on this, the encoding device may encode the bits (4-bit) of the exponent to 1011(3+8(bias)), the bits (1-bit) of the sign to “0” (positive number), and the bits of the mantissa to 00010000011.

The encoding device may represent the encoded data by splitting the encoded data into one exponent brick data and three mantissa brick data. The three mantissa brick data may be split into top brick data, middle brick data, and bottom brick data, and a top brick may include one sign bit and three mantissa bits. In the above example, the exponent brick data may be 1011, the top brick data may be 0000, the middle brick data may be 1000, and the bottom brick data may be 0011.

The 4-bit exponent brick data and the 4-bit top/middle/bottom brick data may be easy to split in hardware. In addition, since an exponent difference that is always considered in a floating-point addition operation is always a multiple of “4”, a structure for fusing multiplicands using fixed-point adders without particular shifting may be possible.

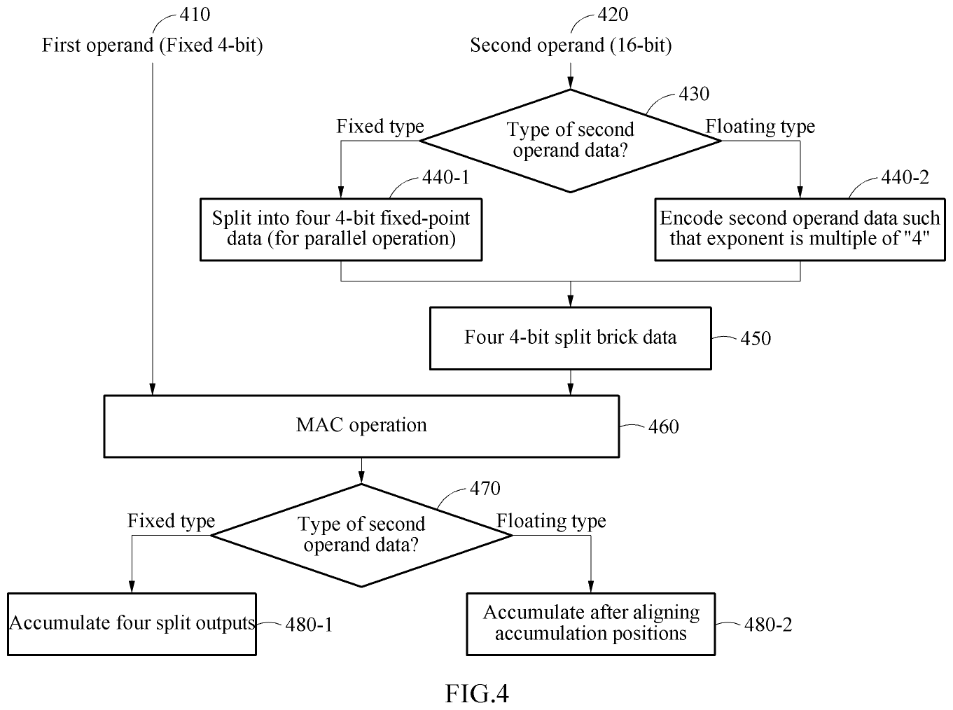

FIG. 4 illustrates an example of an operation method.

Referring to FIG. 4, an operation device may receive first operand data 410 represented by a 4-bit fixed point and second operand data 420 that are 16 bits wide. The operation device may include the encoding device described with reference to FIGS. 2 and 3. The first operand data may be weights and/or an input feature map, and the second operand data may be a gradient.

In operation 430, the operation device may determine a data type of the second operand data.

If the second operand data 420 are of a fixed-point type, the operation device may split the second operand data 420 into four 4-bit bricks for a parallel data operation, in operation 440-1.

If the second operand data 420 are of a floating-point type, the operation device may encode the second operand data 420 according to the method described with reference to FIGS. 2 and 3, in operation 440-2. For example, the operation device may adjust a number of bits of an exponent and a mantissa of the second operand data, so as to split the second operand data 420 into 4-bit units, and encode the second operand data in which the number of bits is adjusted such that the exponent is a multiple of “4”.

In operation 450, the operation device may split the encoded second operand data into four 4-bit bricks. In detail, the operation device may split the encoded second operand data into one exponent brick data and three mantissa brick data.

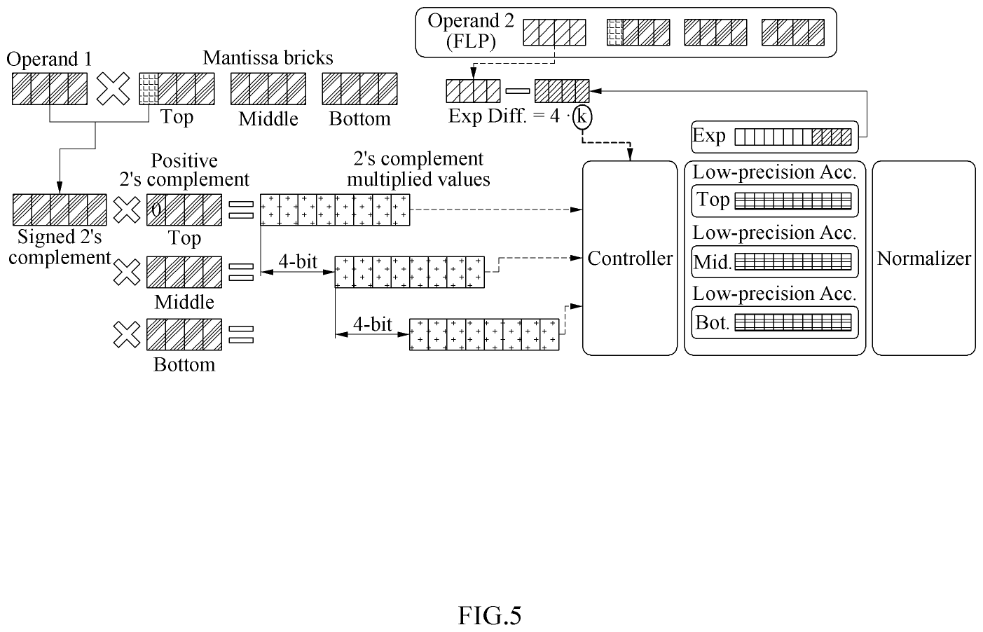

In operation 460, the operation device may perform a MAC operation between the second operand data split into the four bricks and the first operand data 410. The operation device may perform a multiplication operation between the first operand data 410 and each of the three mantissa brick data. The example of performing a MAC operation between the second operand data split into the four bricks and the first operand data 410 will be described in detail with reference to FIG. 5.

In operation 470, the operation device may determine the data type of the second operand data.

If the second operand data 420 are of a fixed-point type, the operation device may accumulate the four split outputs, in operation 480-1.

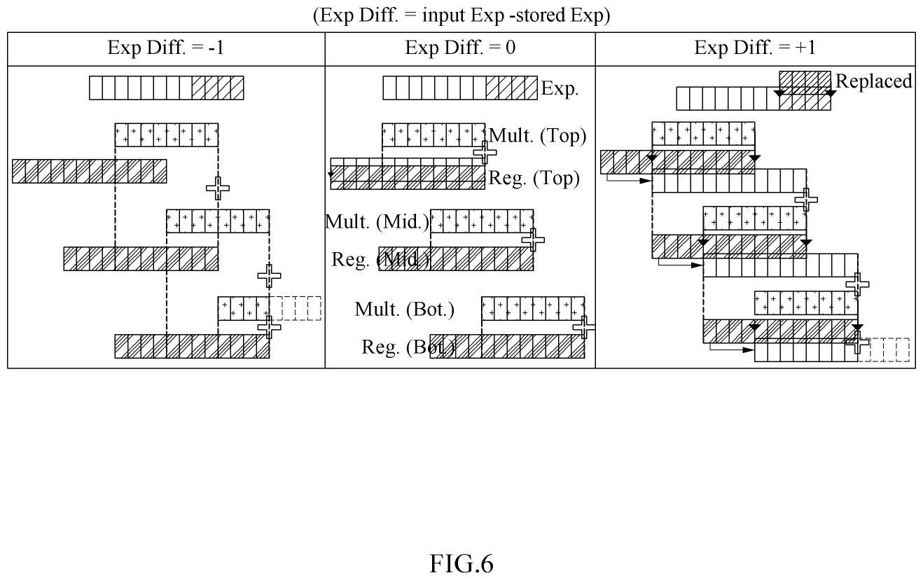

If the second operand data 420 are of a floating-point type, the operation device may compare the exponent brick data with accumulated exponent data stored in an exponent register, and accumulate a result of performing the multiplication operation to accumulated mantissa data stored in each of three mantissa registers, based on a result of the comparing, in operation 480-2. In detail, the operation device may perform the accumulation by aligning accumulation positions of the result of performing the multiplication operation and the accumulated mantissa data stored in each of the three mantissa registers, based on the result of the comparing. The example of accumulating a result of performing the multiplication operation to accumulated mantissa data stored in each of three mantissa registers, based on a result of the comparing will be described in detail with reference to FIG. 6.

FIG. 5 illustrates an example of performing a multiply-accumulate (MAC) operation between first operand data represented by a 4-bit fixed point and second operand data represented by a 16-bit half floating point.

Referring to FIG. 5, an operation device may include a 4×4 multiplier, an exponent register, and three mantissa registers. The three mantissa registers may include a top brick register that stores an operation result for top brick data, a middle brick register that stores an operation result for middle brick data, and a bottom brick register that stores an operation result for bottom brick data.

If second operand data are of a 16-bit half floating-point type, the operation device may split the three mantissa into three 4-bit brick data and perform multiplications with first operand data through the 4×4 multiplier. Three multiplication results obtained thereby may be aligned according to an exponent difference, which is a difference between exponent brick data and accumulated exponent data stored in the exponent register, and the results of performing the multiplication operations may be respectively accumulated to accumulated mantissa data stored in the mantissa registers and stored.

FIG. 6 illustrates an example of aligning data according to an exponent difference.

Referring to FIG. 6, a mantissa register provided to accumulate 8-bit (4 bit×4 bit) data, which are outputs of a multiplier, is configured in 12 bits. An operation device may accumulate the data by designating positions of the outputs of the multiplier according to an exponent difference.

For example, if the exponent difference is “0” (if an exponent of second operand data is greater than stored accumulated exponent data), the operation device may accumulate the data by aligning a multiplication operation result and accumulated exponent data stored in each of three mantissa registers at the same positions.

If the exponent difference is “−1” (if the exponent of the second operand data is greater than the stored accumulated exponent data), the operation device may accumulate the data by aligning the multiplication operation result to be 4-bit shifted rightward from the accumulated exponent data stored in each of the three mantissa registers.

If the exponent difference is “1” (if the exponent of the second operand data is less than the stored accumulated exponent data), the operation device may accumulate the data by aligning the multiplication operation result to be 4-bit shifted leftward from the accumulated exponent data stored in each of the three mantissa registers.

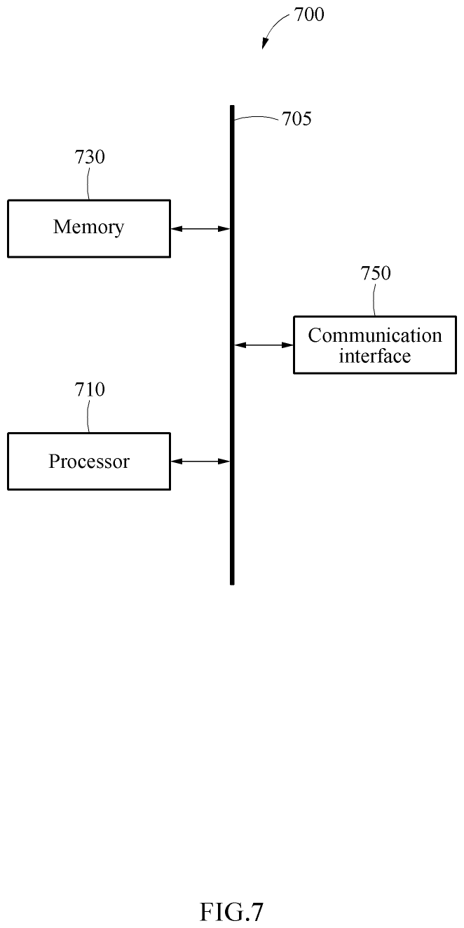

FIG. 7 illustrates an example of an operation device.

Referring to FIG. 7, an operation device 700 includes a processor 710. The operation device 700 may further include a memory 730 and a communication interface 750. The processor 710, the memory 730, and the communication interface 750 may communicate with each other through a communication bus 705.

The processor 710 may receive first operand data represented by a 4-bit fixed point, receive second operand data that are 16 bits wide, determine a data type of the second operand data, encode the second operand data, if the second operand data are of a floating-point type, split the encoded second operand data into four 4-bit bricks, and perform a MAC operation between the second operand data split into the four bricks and the first operand data.

The memory 730 may be a volatile memory or a non-volatile memory.

In some examples, the processor 710 may adjust a number of bits of an exponent and a mantissa of the second operand data, so as to split the second operand data into 4-bit units, and encode the second operand data in which the number of bits is adjusted such that the exponent is a multiple of “4”.

The processor 710 may split the encoded second operand data into one exponent brick data and three mantissa brick data.

The processor 710 may perform a multiplication operation between the first operand data and each of the three mantissa brick data, compare the exponent brick data with accumulated exponent data stored in an exponent register, and accumulate a result of performing the multiplication operation to accumulated mantissa data stored in each of three mantissa registers, based on a result of the comparing.

The processor 710 may align accumulation positions of the result of performing the multiplication operation and the accumulated mantissa data stored in each of the three mantissa registers, based on the result of the comparing.

In addition, the processor 710 may perform the at least one method described above with reference to FIGS. 1A to 6 or an algorithm corresponding to the at least one method. The processor 710 may execute a program and control the operation device 700. Program codes to be executed by the processor 710 may be stored in the memory 730. The operation device 700 may be connected to an external device (for example, a personal computer or a network) through an input/output device (not shown) to exchange data therewith. The operation device 700 may be mounted on various computing devices and/or systems such as a smart phone, a tablet computer, a laptop computer, a desktop computer, a television, a wearable device, a security system, a smart home system, and the like.

The operation device, and other devices, apparatuses, units, modules, and components described herein with respect to FIGS. 1A through 7, such as the CNN 20, the processing elements (PEs) 141, 142, 143, 144, 145, 146, 147, 149, and 149, the processor 710, the memory 730, and the communication interface 750 are implemented by hardware components. Examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices that is configured to respond to and execute instructions in a defined manner to achieve a desired result. In one example, a processor or computer includes, or is connected to, one or more memories storing instructions or software that are executed by the processor or computer. Hardware components implemented by a processor or computer may execute instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. A hardware component may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods illustrated in FIGS. 1A-7 that perform the operations described in this application are performed by computing hardware, for example, by one or more processors or computers, implemented as described above executing instructions or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations.

Instructions or software to control a processor or computer to implement the hardware components and perform the methods as described above are written as computer programs, code segments, instructions or any combination thereof, for individually or collectively instructing or configuring the processor or computer to operate as a machine or special-purpose computer to perform the operations performed by the hardware components and the methods as described above. In one example, the instructions or software include machine code that is directly executed by the processor or computer, such as machine code produced by a compiler. In another example, the instructions or software include higher-level code that is executed by the processor or computer using an interpreter. Programmers of ordinary skill in the art can readily write the instructions or software based on the block diagrams and the flow charts illustrated in the drawings and the corresponding descriptions in the specification, which disclose algorithms for performing the operations performed by the hardware components and the methods as described above.

The instructions or software to control a processor or computer to implement the hardware components and perform the methods as described above, and any associated data, data files, and data structures, are recorded, stored, or fixed in or on one or more non-transitory computer-readable storage media. Examples of a non-transitory computer-readable storage medium include read-only memory (ROM), random-access programmable read only memory (PROM), electrically erasable programmable read-only memory (EEPROM), random-access memory (RAM), dynamic random access memory (DRAM), static random access memory (SRAM), flash memory, non-volatile memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, blue-ray or optical disk storage, hard disk drive (HDD), solid state drive (SSD), flash memory, a card type memory such as multimedia card micro or a card (for example, secure digital (SD) or extreme digital (XD)), magnetic tapes, floppy disks, magneto-optical data storage devices, optical data storage devices, hard disks, solid-state disks, and any other device that is configured to store the instructions or software and any associated data, data files, and data structures in a non-transitory manner and providing the instructions or software and any associated data, data files, and data structures to a processor or computer so that the processor or computer can execute the instructions.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

What is claimed is:

1. An encoding method, comprising:
receiving input data represented by a 16-bit half floating point;
adjusting a number of bits of an exponent and a mantissa of the input data to split the input data into 4-bit units; and
encoding the input data in which the number of bits has been adjusted such that the exponent is a multiple of “4”.

2. The encoding method of claim 1, wherein adjusting of the number of bits comprises:
assigning 4 bits to the exponent; and
assigning 11 bits to the mantissa.

3. The encoding method of claim 1, wherein the encoding comprises:
calculating a quotient and a remainder obtained when a sum of the exponent of the input data and “4” is divided by “4”;
encoding the exponent based on the quotient; and
encoding the mantissa based on the remainder.

4. The encoding method of claim 3, wherein encoding of the exponent comprises encoding the exponent based on the quotient and a bias.

5. The encoding method of claim 3, wherein encoding of the mantissa comprises determining a first bit value of the mantissa to be “1” if the remainder is “0”.

6. The encoding method of claim 3, wherein encoding of the mantissa comprises determining a first bit value of the mantissa to be “0” and a second bit value of the mantissa to be “1”, if the remainder is “1”.

7. The encoding method of claim 3, wherein encoding of the mantissa comprises determining a first bit value of the mantissa to be “0”, a second bit value of the mantissa to be “0”, and a third bit value of the mantissa to be “1”, if the remainder is “2”.

8. The encoding method of claim 3, wherein encoding of the mantissa comprises determining a first bit value of the mantissa to be “0”, a second bit value of the mantissa to be “0”, a third bit value of the mantissa to be “0”, and a fourth bit value to be “1”, if the remainder is “3”.

9. A non-transitory computer-readable storage medium storing instructions that, when executed by a processor, cause the processor to perform the encoding method of claim 1.

10. An operation method, comprising:
receiving first operand data represented by a 4-bit fixed point;
receiving second operand data that are 16 bits wide;
determining a data type of the second operand data;
encoding the second operand data, if it is determined the second operand data are of a floating-point type, and splitting the encoded second operand data into four 4-bit bricks;
splitting the second operand data into four 4-bit bricks for a parallel data operation, if it is determined the second operand data are of a fixed-point type; and
performing a multiply-accumulate (MAC) operation between the second operand data split into the four bricks and the first operand data.

11. The operation method of claim 10, wherein the encoding comprises:
adjusting a number of bits of an exponent and a mantissa of the second operand data, so as to split the second operand data into 4-bit units; and
encoding the second operand data in which the number of bits is adjusted such that the exponent is a multiple of “4”.

12. The operation method of claim 10, wherein the splitting comprises splitting the encoded second operand data into one exponent brick data and three mantissa brick data.

13. The operation method of claim 12, wherein performing of the MAC operation comprises:
performing a multiplication operation between the first operand data and each of the three mantissa brick data;
comparing the exponent brick data with accumulated exponent data stored in an exponent register; and
accumulating a result of performing the multiplication operation to accumulated mantissa data stored in each of three mantissa registers, based on a result of the comparing.

14. The operation method of claim 13, wherein the accumulating comprises aligning accumulation positions of the result of performing the multiplication operation and the accumulated mantissa data stored in each of the three mantissa registers, based on the result of the comparing.

15. An encoding device, comprising:
a processor configured to receive input data represented by a 16-bit half floating point, adjust a number of bits of an exponent and a mantissa of the input data to split the input data into 4-bit units, and encode the input data in which the number of bits has been adjusted such that the exponent is a multiple of “4”.

16. The encoding device of claim 15, wherein the processor is further configured to assign 4 bits to the exponent and assign 11 bits to the mantissa.

17. The encoding device of claim 15, wherein the processor is further configured to calculate a quotient and a remainder obtained when a sum of the exponent of the input data and “4” is divided by “4”, encode the exponent based on the quotient, and encode the mantissa based on the remainder.

18. An operation device, comprising:
a processor configured to receive first operand data represented by a 4-bit fixed point, receive second operand data that are 16 bits wide, determine a data type of the second operand data, encode the second operand data, if it is determined the second operand data are of a floating-point type and split the encoded second operand data into four 4-bit bricks, split the second operand data into four 4-bit bricks for a parallel data operation, if it is determined the second operand data are of a fixed-point type, and perform a multiply-accumulate (MAC) operation between the second operand data split into the four bricks and the first operand data.

19. The operation device of claim 18, wherein the processor is further configured to adjust a number of bits of an exponent and a mantissa of the second operand data, so as to split the second operand data into 4-bit units, and encode the second operand data in which the number of bits is adjusted such that the exponent is a multiple of “4”.

20. The operation device of claim 18, wherein the processor is further configured to split the encoded second operand data into one exponent brick data and three mantissa brick data.

21. The operation device of claim 20, wherein the processor is further configured to perform a multiplication operation between the first operand data and each of the three mantissa brick data, compare the exponent brick data with accumulated exponent data stored in an exponent register, and accumulate a result of performing the multiplication operation to accumulated mantissa data stored in each of three mantissa registers, based on a result of the comparing.

22. The operation device of claim 21, wherein the processor is further configured to align accumulation positions of the result of performing the multiplication operation and the accumulated mantissa data stored in each of the three mantissa registers, based on the result of the comparing.

23. An operation method, comprising:
receiving first data represented by a 4-bit fixed point;
receiving second data that are 16 bits wide;
encoding the second operand data, in a case in which the second operand data are of a floating-point type, and splitting the encoded second operand data into four 4-bit bricks;
splitting the second operand data into four 4-bit bricks without encoding the second operand data, in a case in which the second operand data are of a fixed-point type; and
performing a multiply-accumulate (MAC) operation between the split second operand data and the first operand data.
